(19) United States
(12) Patent Application Publication
(10) Pub. No.: US 2016/0034993 A1
(43) Pub. Date: Feb. 4, 2016

(54) SYSTEMS AND METHODS TO ALLOCATE THE TIME OF USERS TO ONLINE ACTIVITIES

(71) Applicant: Fairtime S.L., Madrid (ES)

(72) Inventor: Ignacio Linares Rodriguez, Madrid (ES)

(21) Appl. No.: 14/812,789

(22) Filed: Jul. 29, 2015

Related U.S. Application Data
(60) Provisional application No. 62/031,051, filed on Jul. 30, 2014.

(51) Int. Cl. G06Q 30/06; G06Q 20/36

(52) U.S. Cl. CPC G06Q 30/0611; G06Q 20/36

(57) ABSTRACT

A system and method configured to present tasks from bidders to users of a mobile application, based on matching the currently available of time periods offered by the users with the expected time periods required to perform the tasks, matching the core requirements of the tasks with the profiles of the users, prioritizing matched tasks based at least on degrees of matching between the optional requirements of the tasks with the profiles of the users. The mobile application presents content of tasks selected by the end users, monitor user engagement in the time periods during the users performing the selected tasks, collect and report data for the bidders of the user selected tasks, and process payments from the bidders to the users for the completion of the user selected tasks.

### RELATED APPLICATIONS

The present application claims priority to Prov. U.S. Pat. App. Ser. No. 62/031,051, filed Jul. 30, 2014, the entire disclosure of which application is hereby incorporated herein by reference.

### BACKGROUND

Some systems are designed to provide incentives to users for view advertisement content.

For example, U.S. Pat. No. 8,955,006 discloses a system that provides credits to a user based on advertising content presented to a user over a network. The credit can be exchanged for viewing entertainment content.

For example, U.S. Pat. App. Ser. No. 2011/0191151 discloses a system that allows a user to elect to view advertisements while watching other content on a website. The user is awarded points or credits based on the viewing of the advertisement, where the points or credits may be exchanged for goods or merchandise on a separate website.

For example, U.S. Pat. App. Pub. No. 2011/0258024 discloses an incentive system that encourages users to interact with advertisements by providing payments to original users for interaction with advertisements and interaction by users referred by original users.

U.S. Pat. App. Pub. No. 2009/0249388 discloses a remote control device having control functions to control a display of content by a client. A user is confirmed to have viewed an advertisement output by the client through interaction with the advertisement displayed on the remote control device.

U.S. Pat. App. Pub. No. 2002/0087402 discloses a menu of advertisements for user selection. The selected advertisements are downloaded into a set-top box storage and merged with entertainment content for presentation to the user.

### BRIEF DESCRIPTION OF THE DRAWINGS

The embodiments are illustrated by way of example and not limitation in the figures of the accompanying drawings in which like references indicate similar elements.

FIG. 1 shows a system configured to allocate the time of users to perform online activities according to one embodiment.

FIG. 2 illustrates a data processing system according to one embodiment.

FIG. 3 shows a computing system to track user engagement in online activities according to one embodiment.

FIG. 4 shows a data structure to organize user profiles and time offers according to one embodiment.

FIGS. 5-8 illustrate user interfaces to perform a timed task according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

At least some embodiments disclosed herein relate to a technological platform for time exchange, including an application that enables individuals to sell small fractions of their time (e.g., minutes) live at a moment, receive multiple bids from third parties, and complete a given online task at that specific moment in exchange for a payment. The platform presents the bids for selection by the individuals offering their time and processes the payment upon completion of the agreed activity. The platform also includes an electronic exchange that enables authorized operators to precisely define requirements of the profiles of the individuals with whom they may want to engage, program and execute automatic bidding orders, deliver audiovisual content for the online tasks, acquire data produced in the engagement with the individuals offering time for the online tasks and having profiles matching the requirements, and complete payments of the accepted bids.

For example, a mobile application named FAIRTIME is implemented to enable a person (e.g., FAIRTIMER) to sell and/or donate his/her time live through a time exchange (e.g., FAIRTIME EXCHANGE or FTX) in which authorized operators, such as advertisers, companies and non-for-profit organizations, (e.g., FAIRTIME BIDDER) bid in real time for the time of the person.

For example, a FAIRTIMER offers an amount of time available at a given moment. FTX receives a bid from a FAIRTIME BIDDER offering an amount of payment in exchange for an activity to be completed by the FAIRTIMER at that moment. FTX presents the top 5 offers/bids ranked by value to the FAIRTIMER and allows him/her to choose an offer from a winning FAIRTIME BIDDER. When/if the activity is successfully completed, FTX processes the payment from the FAIRTIME BIDDER to the FAIRTIMER the amount offered in the bid.

Following is a detailed description of the procedures and rules governing the use of the FAIRTIME application and the FAIRTIME EXCHANGE (FTX) of one embodiment.

After a FAIRTIMER downloads the FAIRTIME application, he/she is prompted to register (e.g., using an e-mail and password combination).

The FAIRTIME application prompts the FAIRTIMER to complete a questionnaire answering demographic and psychographic questions. The FAIRTIME application has settings allowing the person to specify sectors and brands of interest to the FAIRTIMER, which is used by FAIRTIME to prioritize bids for the FAIRTIMER.

Any time the FAIRTIMER wants, he/she gets access to a main screen of the FAIRTIME application from which time may be sold via FTX. The FAIRTIMER specifies: time, bid nature, and specific interest, as further discussed below.

Time: it indicates how much time the FAIRTIMER offers at this particular moment. There are 3 slots of time from which to choose, where each of the time slots has a predetermined amount of time (e.g., 3, 5, or 10 minutes).

Bid nature: it indicates whether the FAIRTIMER would like to receive payment for the time that he/she makes available at this moment. For example, the FAIRTIMER may select “Paying bids” for commercial purposes, from a for-profit organization, or “Time donation bids” for solidarity purposes, from a non-for-profit organization (there is no money exchange in “Time donation bids”).

Specific interest: it indicates a particular sector of activity of interest to the FAIRTIMER at this time for the offer of the selected time slot. For example, the FAIRTIMER may specify the sector by selecting from a menu that lists all potential sectors available for selection by the FAIRTIMER. In one implementation, such a sector selection for the particular time offer overrules but does not exclude the sector selection made by the FAIRTIMER in the personal preference settings. Bids in the sector selected particularly for the time offer of the FAIRTIMER as well as bids in the sector selected for the personal preference settings of the FAIRTIMER are identified by the FTX for presentation to the FAIRTIMER

The FAIRTIME application transmits the input (e.g., Time, Bid nature, Specific interest) provided by the FAIRTIMER to FAIRTIME EXCHANGE (FTX), triggering a bid matching process that is described further below. In one implementation, the bid matching process on FTX results in a list of top five bids that is communicated from the FTX to the FAIRTIME application. The FAIRTIMER can then select one winning bid from the top five bids ranked by value, presented in a header format.

The header is a table with the following information for each of the five bids: logo of the brand, company, NFP, presenting the bid; value of the bid in local currency; description of the activity (e.g., in 400 characters or less) the bidder would like the FAIRTIMER to perform in the time slot offered by the FAIRTIMER.

The FAIRTIME application is configured to allow the FAIRTIMER to complete the selection of the bid he/she desires within a predetermined period of time (e.g., 60 seconds). Selecting a bid represents the user accepting the bid terms (value and required activity) and triggers the engagement between the FAIRTIMER and the bidder.

Once the engagement and the activity required by the bidder are successfully completed, the FAIRTIMER receives a notification of payment as per the agreed terms of the bid. Payments are made in the local currency, using an e-wallet built into the application in one implementation. The e-wallet is compatible with the use of other third-party payment platforms.

Immediately after receiving payment notification, the FAIRTIMER also receives in his/her inbox (built-in in the FAIRTIME app) a pre-configured message from the bidder. This message may contain text, images, and a link to URL for the bidder.

Before operating as an authorized FAIRTIME BIDDER, the advertiser/company/non-profit completes a registration to provide identification data, such as name, address, contact details, authorized representative, bank records, etc.

The FAIRTIME BIDDER designates a person as the ADMINISTRATOR of its account in the FAIRTIME EXCHANGE (FTX). This person is provided with access to operate in the platform (e.g., presenting bids) on behalf of the registered FAIRTIME BIDDER. This person is also allowed to authorize other individuals as OPERATORS to bid on behalf of the FAIRTIME BIDDER. OPERATORS may only bid on behalf of the FAIRTIME BIDDER.

To create a bid, a web interface configured for the FAIRTIME BIDDER instructs the FAIRTIME BIDDER to provide: Target definition, Budget setting, Bid parameter, Content, Retargeting message, etc.

Target definition specifies the requirements of profiles of FAIRTIMER to whom the FAIRTIME BIDDER wants to present a bid. Requirements on FAIRTIMER Profiles as requested by the FAIRTIME BIDDER may include: CORE PROFILE and DESIRABLE PROFILE.

CORE PROFILE identifies the requirements on the certain variables of the targeted FAIRTIMER Profiles that must be met in order for the FAIRTIME BIDDER to bid for the time offered by the individual having the FAIRTIMER Profile. If the requirement of the CORE PROFILE is not matched at 100% with the Profile of a FAIRTIMER, there is no bid from the FAIRTIME BIDDER for the time offered by the FAIRTIMER.

DESIRABLE PROFILE identifies the requirements on the certain variables of the targeted FAIRTIMER Profiles that may be met in order for the FAIRTIME BIDDER to offer a higher bid for the time offered by the individual having the FAIRTIMER Profile, if the FAIRTIMER Profile also satisfies the requirement of the CORE PROFILE.

The FAIRTIME EXCHANGE (FTX) stores an extensive profile for each FAIRTIMER. A FAIRTIMER profile may have 40+ variables from which a FAIRTIME BIDDER may select to specify the requirement for CORE PROFILE and DESIRABLE PROFILE. The data in the FAIRTIMER profile is collected from the direct responses of the FAIRTIMER to the settings questionnaire when the FAIRTIMER adjusts his/her personal settings in the FAIRTIME app.

Budget setting specified by the FAIRTIME BIDDER sets a budget for its campaign. A campaign is defined by the dates determining the time period during which the FAIRTIME BIDDER is willing to offer bids to FAIRTIMERs satisfying the target definition of the FAIRTIME BIDDER offering times of the FAIRTIMERs in the FTX.

When a FAIRTIMER having a FAIRTIMER profile matching the target definition of the FAIRTIME BIDDER offers time in the FTX, the FAIRTIMER may use the FAIRTIME application to accept a bid from the FAIRTIME BIDDER. FTX processes the following payment operations, only if/when the requested task of the bidder for a given activity is successfully completed.

FTX may deposit a payment to the FAIRTIMER for the value offered in the bid in the electronic wallet (built-in in the FAIRTIME application) of the FAIRTIMER or a third-party payment tool that is capable of handling payment transactions, integrated with the FAIRTIME application. FTX deducts the value of the payment from the budget of the FAIRTIME BIDDER.

Alternatively, FTX may deposit a payment to FAIRTIMER for a value agreed previously with the FAIRTIME BIDDER by contract to a bank account of the FAIRTIMER. FTX deducts the value of the payment from the budget of the FAIRTIME BIDDER.

FTX runs the campaign of the FAIRTIME BIDDER in accordance with the parameters specified by the FAIRTIME BIDDER. The campaign ends when the budget has been depleted or exhausted, or when a predetermined date set by the FAIRTIME BIDDER arrives, whichever happens first.

Bid parameter specified by the FAIRTIME BIDDER sets the minimum and maximum value for its bid. The minimum value is set to be offered to FAIRTIMERs making their time available during the campaign dates and matching the core profile at 100%. The maximum value is set to be offered to FAIRTIMERs making their time available during the campaign dates, matching the core profile at 100%, and matching the desired profile at 100% (both). The bidder may select a first set of profile variables as core requirements and a second set of profile variables as desirable requirements. The meeting of the desirable requirements is optional in matching the task with the profiles of FAIRTIMERs.

If the profile of a FAIRTIMER does not completely satisfy the core requirements of a task of a bidder, the task is not present to the FAIRTIMER. If the profile of a FAIRTIMER satisfies the core requirements of a task of a bidder, the FTX platform is configured to compute a bid for the bidder based on the minimum value, the maximum value, and the degree that the desirable requirements are satisfied.

When the profile of the FAIRTIMER matches the core profile at 100% but the desired profile at less than 100%, the FTX platform automatically prorates the bid arithmetically (divides the difference between minimum and maximum values by the number of desired variables in the complete desired profile to calculate the individual bid value per desired variable and multiplies by the number of matched desired variables).

Content specified by the FAIRTIME BIDDER for the campaign is delivered to the FAIRTIME application the FAIRTIMER during the time offered by the FAIRTIMER. The content may include text and/or audiovisual content transmitted to the computing device (e.g., smartphone, portal media player, personal computer) of the FAIRTIMER on which the FAIRTIME application is running. The consumption of the content is part of the activity/task required to complete in exchange for the payment specified by the bid of the FAIRTIME BIDDER.

The FTX platform collects and delivers the content, as well as any data output derived from the engagement of the FAIRTIMER with this content.

Retargeting message specified by the FAIRTIME BIDDER may be sent by FTX as a follow up message to the FAIRTIMER who has already accepted its bid. This message is delivered to the personal inbox of the FAIRTIMER, wherein the inbox is built-in in the FAIRTIME app. FTX delivers the message immediately after the payment for the successfully completed activity tied to an accepted bid has been completed.

The FTX platform performs the matching between the time offers from FAIRTIMERs and bids from FAIRTIME BIDDERs.

In one embodiment, the FTX platform is configured to score the economic value per offer (bid) from FAIRTIME BIDDERs for a FAIRTIMER selling his/her time in view of the FAIRTIME profile of FAIRTIMER. When a FAIRTIMER has identified a specific area of interest at the moment of offering his/her time, the time offer of the FAIRTIMER is considered a “direct access” request. The FTX prioritizes the so called “direct access” requests. The FTX also take into consideration other environmental inputs, such as location, time of day, day of week, etc. to fine tune the scoring. The FTX then processes the interests specified by the FAIRTIMER in his settings (e.g., in the absence of a direct access request), to produce a preliminary ranking. The final ranking is optimized per user, taking into consideration the following input: campaign duration, target optimization, brand environment, and offer update. The top 5 ranked offers from FAIRTIME BIDDERs are presented to the FAIRTIMER for selection.

In one embodiment, the matching and ranking may further include the consideration of user's evaluation, and/or other considerations.

In one embodiment, when the FAIRTIMER requests “paying bids”, the top 5 offers are presented in the order of the bidding price. When the end user requests “time donation bids”, the top 5 offers are presented in the order determined based on the FAIRTIME profile of the FAIRTIMER, such as the degree of matching between a bid and the interests and skills identified in the FAIRTIME profile.

For instance, a non-profit organization may seek to classify content for children by asking parents to evaluate such content. Hence the platform will forward this task only to parents with children within the age brackets required by the non-profit organization.

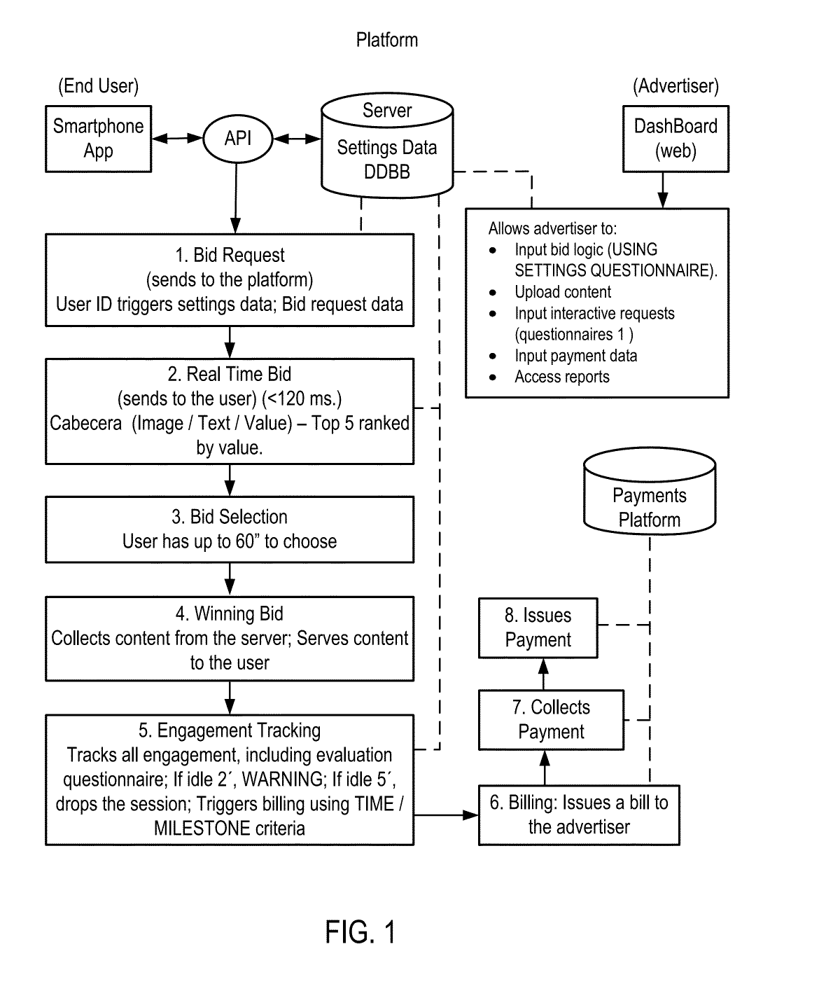

FIG. 1 illustrates the operating flow of the FAIRTIME application and FTX platform.

In FIG. 1, when the end user (FAIRTIMER) registers to use the smartphone application (FAIRTIME), the application asks the end user a set of questions to collect data for the profile variables of the end user.

Examples of profile variables include Demographics variables and Psychographics variables.

To collect data for the Demographics variables, the application is configured to ask the FAIRTIMER questions, such as

What is your nationality?

What is your native language?

What other languages do you speak?

What is your gender?

What is your age?

What is your country of residency?

What is your city of residency?

What is your highest education degree?

What is your marital status?

(Including you) How many people live in your home?

What is your role in the house?

Do you have dependent children? If so, how many and how old are the children?

What is your current work situation?

What is your annual gross income?

To collect data for the Psychographics variables, the application is configured to ask the FAIRTIMER whether he/she agrees or disagrees with assertions, such as:

I like buying brands with ethical values and which support social causes

I like shopping

I am willing to pay more for a good product

Normally, I am willing to sacrifice quality for a lower Price

I believe one should take less care of oneself and enjoy more

The products and brands I buy and use say a lot about m

I care about the way I look, I like taking care of my body

Generally, I like buying well-known brands

I normally buy only the things I need

I rather treat myself now than save for the future

I value costumer service (assessment, kindness . . . ) above product price

I am a prudent and thoughtful person

I am a rather calmed person

I like classic style, what perdures over time

I don't care what the others may think about m

I dedicate a lot of time to my family e

I tend to do things by myself, instead of seeking someone to tell me how to do it

I like taking risks when making decisions

I don't care working more hours if it implies a professional improvement

I'd like to have everything under control

I like being up to date and I follow trends in fashion

It bothers me having to make changes in my life

I contribute money to some NGO

I normally buy products on Internet

I like meeting people

In FIG. 1, the dashboard allows a FAIRTIME BIDDER (e.g., an advertise) to define tasks offered to be performed by the FAIRTIMER (end user).

For example, an advertiser may provide the following description of a task:

“Take a look at our upcoming commercial for the new Golf. Then, give us your opinion: which one of the 3 possible endings should we choose?”

For example, a non-profit organization may provide the following description of a task:

“Show me around! Millions of kids around the world are kept inside the hospital. They can't visit your city, but you can bring it to them. Take a five minutes tour of your favorite places in your neighborhood (pictures, videos) and open a window to the World for them!”

In FIG. 1, the platform matches the profile of the FAIRTIMER with the profile request of the OPERATOR (FAIRTIME BIDDER, e.g., an advertiser or a non-profit organization). The smartphone application presents up to 5 task offers; and the end user (FAIRTIMER) is to make the final task selection.

In one embodiment, the platform is capable of delivering content in the following formats to facilitate the administration of the task: Video, Pictures, Text, URL links, Questionnaires (e.g., in the form of free text/binary/multiple choice/one of several), etc.

After the end user completes the task, the platform is capable of reporting the information about the completed task(s), such as Responses to ad hoc questionnaires as part of the content, Table with selected profile, Total number of bids in the FTX platform for that profile during the time of the campaign, % of that total that were won by the brand, iv. Bid price distribution for that profile and time period (graphic), % of bids which completed engagement, Time length distribution of failed session (graphic), In content engagement report (graphic), Post engagement report (graphic).

In FIG. 1, the server and/or the app is configured to perform engagement tracking to monitor the user interaction with the app during the time period of the task.

In one embodiment, the tasks are configured for predetermined time periods (e.g., 3 minutes, 5 minutes, 10 minutes; or other predetermined sets of time periods); and the smartphone app is configured to allow the end user to specify a free time that is in one of the predetermined time periods. The platform is configured to serve bids that match the length of the time offered by the end user.

In one embodiment, the platform is capable of measuring the video length when uploading, as well as estimating the time required to complete a questionnaire by an average user. If a mismatch is detected the OPERATOR (a representative of the FAIRTIME BIDDER, e.g., an advertiser or a non-profit organization) is requested to edit before proceeding with the campaign.

In FIG. 1, if the FAIRTIMER goes idle (he could be taking an incoming call), the smartphone app provides a warning if a two-minute idle is detected, and shut down the session if a five-minute idle is detected.

In one embodiment, to present a bid, the smartphone app is configures to show a logo of the bidder, a task description, and a bid value of the task.

In one embodiment, the platform is implemented on a data processing system. The advertiser and/or the end user may use a computing device configured based on a data processing system to access the services provided by the platform.

FIG. 3 shows a computing system to track user engagement in online activities according to one embodiment.

In FIG. 3, a server computer (221) is configured with a data storage device, such as database (227), to store the profiles of registered users of user devices (223, . . . , 225). The server computer (221) communicates with the user devices (223, . . . , 225) to present the user interfaces for entering and/or modifying profile data, time offer, bid campaign, etc.

For example, the server (221) may provide a mobile application that is downloaded from the server (221) to the user device (e.g., 223) for execution as a mobile application to present the user interfaces for specifying the profile data and/or time offer of a FAIRTIMER. The mobile application running on the user device (223) communicates the data to and/or from the server (221). Alternatively, the server (221) may provide one or more web documents to present the user interfaces.

For example, the server (221) may provide a mobile application that is downloaded from the server (221) to the user device (e.g., 223) for execution as a mobile application to present the user interfaces for specifying a bid campaign of a FAIRTIME BIDDER. The mobile application running on the user device (223) communicates the data to and/or from the server (221). Alternatively, the server (221) may provide one or more web documents to present the user interfaces.

In FIG. 3, the server (221) stores the profile data of FAIRTIMERs in the database (227). When a FAIRTIMER provides an offer of a selected period of time, the server (221) identifies bids from FAIRTIME BIDDERS and rank the bids according to the degree of matching between the interest of the FAIRTIMER, as specified in the offer and/or in the profile of the FAIRTIMER, and the interest of the FAIRTIME BIDDERS, as specified in the bid campaigns of FAIRTIME BIDDERS, and the degree of matching between the profile variables of the FAIRTIMER, and the profile requirements of the bid campaigns. The server further ranks the bids based on the bid prices.

In FIG. 3, after the FAIRTIMER using the user device (223) selects a winning bid, the server (221) transmits the content data associated with the winning bid from the database (227) to the user device (223) for presentation. The server (221) and/or the mobile/web application running on the user device (223) is configured to monitor the engagement of the user with a presentation of the presented content data. For example, the server (221) and/or the mobile/web application may determine if the presentation of the content data is placed in an idle mode or in a background process for more than a threshold period of time. For example, the server (221) and/or the mobile/web application may determine if the user fails to provide an input within a predetermined period of time. If the server (221) and/or the mobile/web application determines that the FAIRTIMER failed to sufficiently engaging with the task and/or the consumption of the content data associated with the winning bid, the assignment of the task to the FAIRTIMER is revoked.

Upon successful completion of the task and/or the consumption of the content data associated with the winning bid, the server (221) uses the clearing facility (223) to process a payment from the FAIRTIME BIDDER to the FAIRTIMER.

In FIG. 3, the server (221) is coupled with the administration device (225) to present user interfaces to perform administrative tasks, such as blocking or unblocking certain FAIRTIMERs from accessing certain or all tasks.

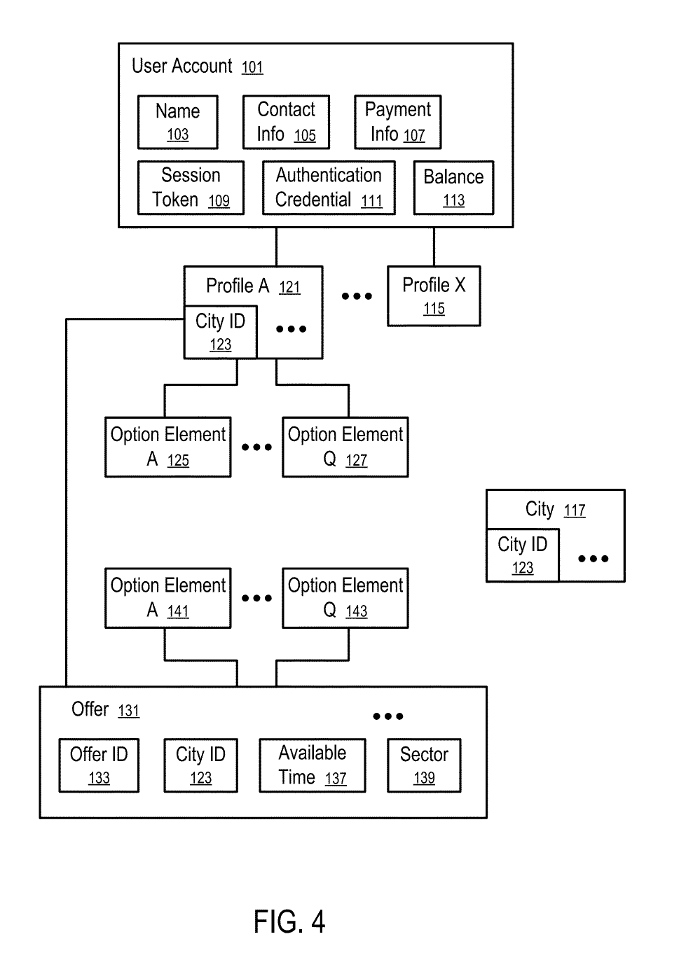

FIG. 4 shows a data structure to organize user profiles and time offers according to one embodiment.

In FIG. 4, the user account (101) has data fields, such as the name (103) of the user (FAIRTIMER), the contact information (105) of the user, the payment information (107) of the user to receive payments from bidders (FAIRTIME BIDDERS), the current balance of the user, the authentication credential (111) of the user, etc. In one embodiment, a user is limited to have one active session at a given time. Thus, the user account (101) stores a session token (109) identifying a currently active session of the user, if such a session exists.

In FIG. 4, a user account (101) may have multiple profiles (e.g., 121, 115). Each profile contains a number of data fields (e.g., identifying the city of the user using a city ID (123) that identifies a profile (117) of a city (123).

In FIG. 4, a profile (121) is linked to one or more optional elements (e.g., 125, . . . , 127). The optional elements are created when the profile variables of the corresponding optional elements are selected and provided with data input by the user. The use of the optional elements allows to system to balance the flexibility to specify an arbitrary subset of available profile attributes, and the efficiency of the database.

In FIG. 4, an offer (131) of the user (FAIRTIMER) is linked to a profile (121) of the user to indicate the preference of the user in making the offer. The offer (131) of the user is identified by the offer ID (133) with a number of fields, such as city ID (123) indicating the city in which the user is in at the time of the offer (131), available time (137) (e.g., selected from a set of predetermined time periods, such as 3 minutes, 5 minutes, 10 minutes), the sector (139) of interest to the user, etc. The offer (131) may further includes option elements (e.g., 141, 143) configured in a way option elements (e.g., 125, 127) are added to the profile (121).

In one embodiment the preferences identified in the offer (131) by the sector (139) and the option elements (e.g., 141, 143) has priority over the preferences specified in the profile (121) to which the offer (131) is link, which has priority over other profiles (e.g., 115). Such an arrangement provides a hierarchy of preferences for the user for the specific offer (131), allowing the server (221) to rank bids to better tailor the current preference of the user. The arrangement also simplifies the user effort to specify preferences for the current offer (131).

In one embodiment, the user interfaces are presented via a module embedded in a third party application, such as a third party mobile application, or a third party web application. The third party application runs the module inside the application to provide the FAIRTIME functionality with the third party application.

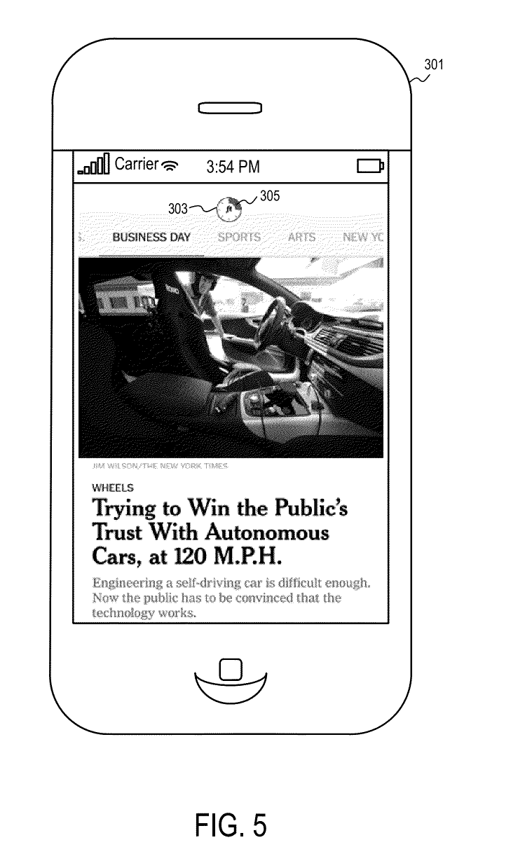

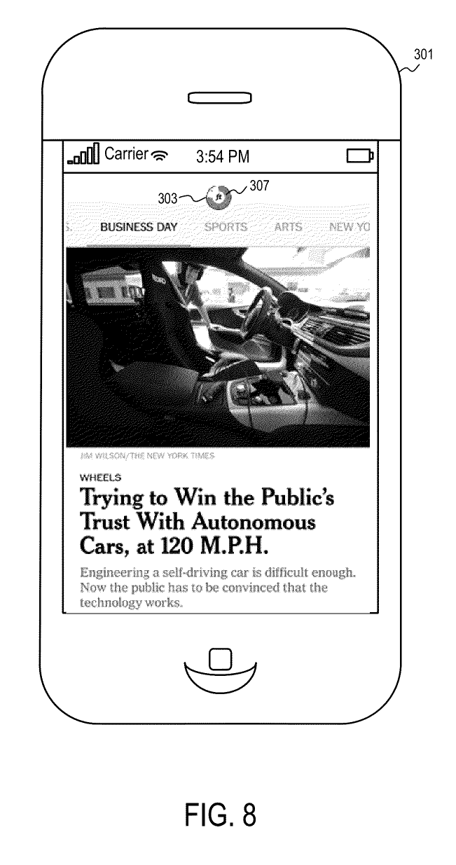

For example, the third party application may use a timer provided by the module to time the use of the third party application the user of the application. When the use of the third party application reaches a predetermined threshold of time period, the module requests the user to complete an engagement through the module (e.g., to earn further rights to use the third party application). Thus, the user is requested to offer a period of time to complete a task presented by FAIRTIME in exchange for the right to continue the use of the third party application (e.g., to continue playing a game, consuming media content). The engagement can be configured to require the user to consume specific content, including questionnaires and data entry forms, and respond to a call to action by the module. Upon the successful completion of the engagement, the user gains the rights to extend the use of third party application, as illustrated in FIGS. 5-8.

FIGS. 5-8 illustrate user interfaces to perform a timed task according to one embodiment.

In FIG. 5, an application running in the user device (301) presents an icon (303) via using a FAIRTIME module in the application, or make a service call through a FAIRTIME API. The FAIRTIME module can be provided via an software development kit to make the service call through the FAIRTIME API.

In response to the service call to the server (221), the user device (301) presents the icon (303) to time the use of the application running in the user device (301). The icon (303) indicates the amount of time the user may access the application before being requested to complete an engagement.

In FIG. 5, the icon (303) has a graphic FIG. (305) conveying time consumption of the application, which is clearly visible to the user in the screen he/she uses to access the application.

When the icon displaying time has been consumed beyond a given amount (e.g., specified in the service call to initially activate icon (303)), the FAIRTIME module/service signals the user the need to complete an engagement. In one embodiment, the request for an engagement needs not be fulfilled at this time. The user is provided with a period of time between the first request and a subsequent second request during which the user is required to complete the engagement.

In FIG. 5, the user may click on the icon (305) to launch FAIRTIME. If the user does not click on the icon (305), the icon (303) launches FAIRTIME at the end of the period of time between the the first request and the subsequent second request.

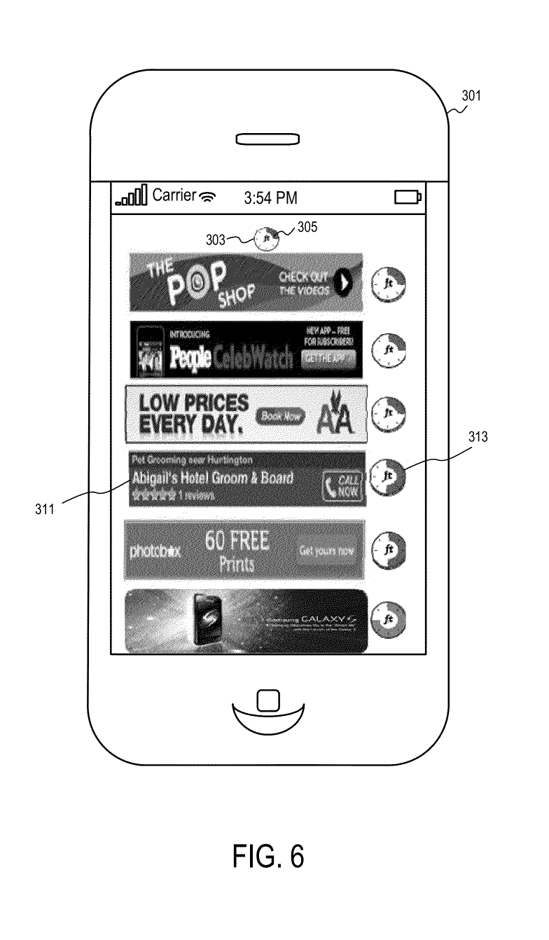

After FAIRTIME is launched, the application calls the server (221) via the FAIRTIME module and/or FAIRTIME API to request being served the content the user is required to engage with, in a way as illustrated in FIG. 6.

In FIG. 6, several items are displayed on the screen so the user may choose one of them for further interaction. Each one of these items is associated with an amount of time of use of the application the user may earn by engaging with it. For example, if the user selects the item (311) for interaction and completes the engagement, the user is to be awarded with the amount of time identified the icon (313) associated with the item (311). The association is made clear by presenting the icon (313) right next to the item (313). It could also indicate access to specific rights of use of the application, such as access to premium content for a publisher, access to special features in a game, etc.

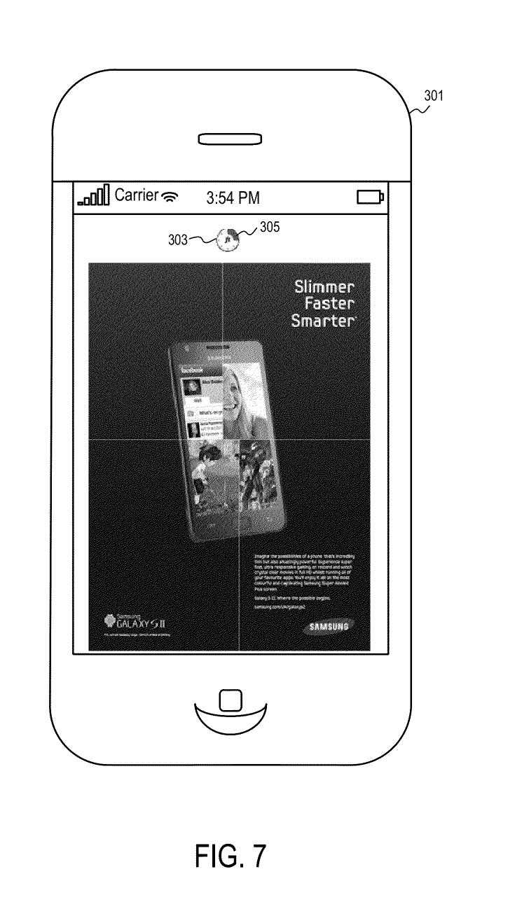

By selecting an item (e.g., 311), the user initiates an engagement which typically includes: a) a video, b) a questionnaire, and/or c) a call to action which may be completed by the user from that same screen presenting the content, as illustrated in FIG. 7. For example, the user may click a button to share his/her experience through other applications, such as instant messaging, social networks, etc.

Once the engagement is completed, the user returns to the prior screen of application from which FAIRTIME was launched. The timer of the icon (307) is reset to indicate the time period in which the user may continue using the application with being required to perform an engagement.

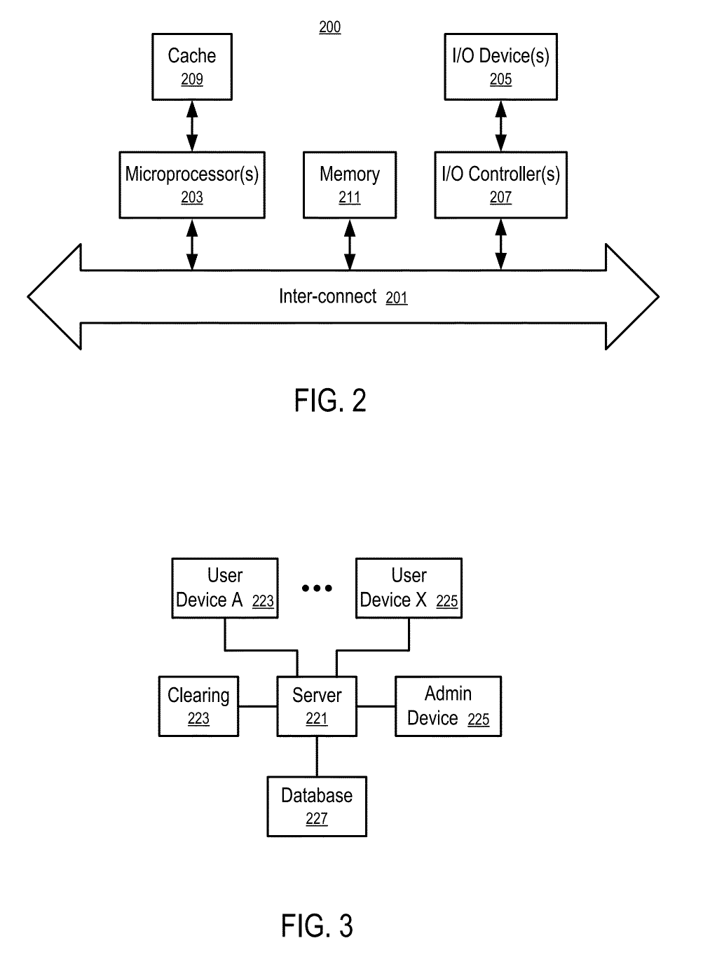

FIG. 2 illustrates a data processing system according to one embodiment. While FIG. 2 illustrates various components of a computer system, it is not intended to represent any particular architecture or manner of interconnecting the components. One embodiment may use other systems that have fewer or more components than those shown in FIG. 2.

In FIG. 2, the data processing system (200) includes an inter-connect (201) (e.g., bus and system core logic), which interconnects a microprocessor(s) (203) and memory (211). The microprocessor (203) is coupled to cache memory (209) in the example of FIG. 2.

In one embodiment, the inter-connect (201) interconnects the microprocessor(s) (203) and the memory (211) together and also interconnects them to input/output (I/O) device(s) (205) via I/O controller(s) (207). I/O devices (205) may include a display device and/or peripheral devices, such as mice, keyboards, modems, network interfaces, printers, scanners, video cameras and other devices known in the art. In one embodiment, when the data processing system is a server system, some of the I/O devices (205), such as printers, scanners, mice, and/or keyboards, are optional.

In one embodiment, the inter-connect (201) includes one or more buses connected to one another through various bridges, controllers and/or adapters. In one embodiment the I/O controllers (207) include a USB (Universal Serial Bus) adapter for controlling USB peripherals, and/or an IEEE-1394 bus adapter for controlling IEEE-1394 peripherals.

In one embodiment, the memory (211) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer system, comprising:
a data storage device configured to host a database; and
a server coupled with the data storage device and configured to provide user
interfaces to a plurality of users via a computer network, the user interfaces including
first user interfaces to specify profiles of the users, wherein the server is configured to store the profiles in the database;
second user interfaces to specify, by the users, offers of segments of time period for online activities, wherein the server is further configured to match the offers of the users to online tasks to identify task candidates by:
matching the segments of time period offered by the users with time requirements of the online tasks; and
determining compatibility between requirements of the online tasks and qualification specified in the profiles of the users; and
third user interfaces to present task candidates to the users for selection;
wherein in response to a user selecting a first task presented via the third user interfaces, the server presents content of the first task to the user within a time period of the first task, interacts with the user to monitor user attention to the content of the first task, and provides a credit to the user after the time period of the first task.

2. The computer system of claim 1, wherein the content of the first task is presented in a communication session; and the session is closed without a credit to the user after the session is idle for a first predetermined period of time.

3. The computer system of claim 2, wherein a warning is provided to the user after the session is idle for a second predetermined period of time shorter than the first predetermined period of time.

4. The computer system of claim 1, wherein the server is configured to provide a mobile application for installation on mobile devices of users, the mobile application configured to present the first user interfaces, the second user interfaces, and the third user interfaces.

5. The computer system of claim 1, further comprising:
a payment platform coupled with the data storage device, the payment platform configured to transfer credits earned by the users to bank accounts of the users.

6. The computer system of claim 1, wherein the server is configured to provide an administration user interface to block or unblock users from accessing the online tasks.

7. The computer system of claim 1, wherein the server is configured to receive real time bids from the online tasks for payments to users performing the online tasks using the segments of time period offered by the users, wherein the task candidates are selected based at least in part on the real time bids.

8. The computer system of claim 7, wherein the real time bids are received in the server within a predetermined time period from a bid request for an offer of a time segment.

9. The computer system of claim 8, wherein after a set of task candidates are presented to the user in a user interface, the user is instructed to select, within a predetermined period of time, a task for completion.

10. The computer system of claim 1, wherein the online tasks are configured to be completed within a time period selected from a predetermined time periods.

11. The computer system of claim 1, wherein the server comprises at least one microprocessor and a memory storing instructions configured to instruct the at least one microprocessor to perform operations.

12. The computer system of claim 1, wherein the content of the first task includes a questionnaire configured to receive input from the user to monitor user attention to the content of the first task.

13. A non-transitory computer storage media storing instructions configured to instruct a computing apparatus to perform a method, comprising:
receiving, via a web interface, tasks from bidders, each task including core requirements and optional requirements and configured to be completed within one of a set of time periods of predetermined lengths;
receiving, via a mobile application running on mobile devices of end users, profile information of the end users;
receiving, via the mobile application running on a mobile device of a first end user, a real time offer of a time period selected from the set of time periods of the predetermined lengths;
identifying a set of bids of tasks by
matching the offer of the time period with time periods of the tasks,
matching the core requirements of the tasks with a profile of the first user, and
prioritizing matched tasks based at least on a degree of matching between optional requirements and the profile of the first user;
presenting via the mobile application, the identified set of tasks;
in response to the first user selecting a first task from the identified set of tasks, providing content to the user to complete the task;
tracking user engagement in the time period offered by the first user; and
providing data about completion of the task by the first user to a bidder of the first task.

14. A method, comprising:
receiving, via a web interface, tasks from bidders, each task including core requirements and optional requirements and configured to be completed within one of a set of time periods of predetermined lengths;
receiving, via a mobile application running on mobile devices of end users, profile information of the end users;
receiving, via the mobile application running on a mobile device of a first end user, a real time offer of a time period selected from the set of time periods of the predetermined lengths;
identifying, by a computing apparatus, a set of bids of tasks by
matching the offer of the time period with time periods of the tasks,
matching the core requirements of the tasks with a profile of the first user, and
prioritizing matched tasks based at least on a degree of matching between optional requirements and the profile of the first user;
presenting, via the mobile application, the identified set of tasks;
in response to the first user selecting a first task from the identified set of tasks, providing by the computing apparatus content to the user to complete the task;
tracking, by the computing apparatus, user engagement in the time period offered by the first user; and
providing, by the computing apparatus, data about completion of the task by the first user to a bidder of the first task.

15. The method of claim 14, further comprising:
providing a warning to the first user in response to a determination of lack of user engagement in the first task for a first predetermined period of time.

16. The method of claim 15, further comprising:
canceling assignment of the first task to the first user in response to a determination of lack of user engagement in the first task for a second predetermined period of time.

17. The method of claim 14, further comprising:
providing an administration user interface to block or unblock users from accessing the tasks.

18. The method of claim 14, further comprising:
receiving, in the computing apparatus between the real time offer and the presenting of the identified set of tasks, real time bids payments to users performing the tasks.

19. The method of claim 14, wherein the tracking of user engagement in the time period offered by the first user includes collecting answers from the first user during the time period offered by the first user.

20. The method of claim 14, further comprising;
transferring, by the computing apparatus, a payment from the bidder to the first user after completion of the task by the first user.
